(19) United States
(12) Patent Application Publication
(10) Pub. No.: US 2005/0018750 A1
(43) Pub. Date: Jan. 27, 2005

(54) Ultra-wideband transceiver architecture and associated methods

(76) Inventors: Jeffrey R. Foerster, Portland, OR (US); Srinivasa Somayazulu, Portland, OR (US); Sumit Roy, Seattle, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/379,395

(22) Filed: Mar. 3, 2003

(51) Int. Cl. H04B 1/69

(52) U.S. Cl. 375/130

(57) ABSTRACT

An ultra-wideband transceiver architecture and associated methods are generally described.

### TECHNICAL FIELD

Embodiments of the invention generally relate to wireless communication systems and, more particularly, to an ultra-wideband transceiver architecture and associated methods.

### BACKGROUND

Ultra-wideband (UWB) signals, according to one commonly held definition, are exemplified by a signal spectrum wherein the bandwidth divided by the center frequency is roughly 0.25. The use of ultra-wideband (UWB) signals for wireless communication, in its most basic form, has been around since the beginning of wireless communications. However, today's wireless communication environment poses many challenges to the design of ultra-wideband communication systems including, for example, the lack of a worldwide standard for ultra-wideband communications, the potential interference with narrowband wireless systems, interference with other ultra-wideband applications (e.g., RADAR, etc.), and the list goes on. Those skilled in the art will appreciate that the sheer number of such design challenges has heretofore dampened research efforts and, as such, deployment of such ultra-wideband communication solutions.

### BRIEF DESCRIPTION OF THE DRAWINGS

Embodiments of the present invention is illustrated by way of example, and not by way of limitation, in the figures of the accompanying drawings in which like reference numerals refer to similar elements and in which:

FIG. 1 is a block diagram of an example transmitter architecture, in accordance with one example embodiment of the present invention;

FIG. 2 is a graphical illustration of time-frequency codes applied to symbols for transmission, according to disparate embodiments of the present invention;

FIG. 3 is a time frequency graph depicting the use of extended time frequency codes, according to one embodiment of the present invention;

FIG. 4 provides graphical representations of a modulated symbol as well as a time-frequency graph of such modulated symbol(s), according to one embodiment of the invention;

FIG. 5 illustrates a block diagram of an example receiver architecture, according to one example embodiment of the present invention;

FIG. 6 illustrates a block diagram of an example radio frequency front end, according to one example embodiment of the present invention;

FIG. 7 is a flow chart of an example preamble detection method, according to one embodiment of the present invention;

FIG. 8 illustrates a block diagram of an example coarse timing acquisition circuit, according to one embodiment of the present invention;

FIG. 9 is a block diagram of an example fine timing acquisition circuit, according to one embodiment of the invention;

FIG. 10 is a block diagram of an example narrowband interference (NBI) detection feature, according to one embodiment of the invention;

FIG. 11 is a block diagram of an example digital back end, according to one embodiment of the present invention; and

FIG. 12 is a flow chart of an example method for establishing piconets using frequency hopping, according to one example embodiment of the invention; and

FIG. 13 is a block diagram of a storage medium comprising content which, when executed by an accessing communications device, causes the communication device to implement at least one aspect of an embodiment of the invention, according to one embodiment of the invention.

### DETAILED DESCRIPTION

Embodiments of the invention are generally directed to one or more of an ultra-wideband transmitter architecture; an ultra-wideband receiver architecture; methods for generating a multiband ultra-wideband (MB-UWB) communication channel(s) to communicate information between a transmitter and receiver; and/or methods for receiving MB-UWB communication channel(s) and extracting information therefrom, although the invention is not limited in this regard.

According to one aspect of the invention, to be described more fully below, a transmitter architecture and associated methods to generate a multiband ultra-wideband (MB-UWB) signal for transmission via one or more antenna(e) is presented, wherein the generated MB-UWB signal is composed of a number (M) of sequential or parallel pulses within any of a number (N) of narrower bands, wherein the number of sequential or parallel pulses (M) within at least a subset of such bands is greater than one (1).

According to another aspect of the invention, to be described more fully below, a receiver architecture and associated methods are presented to demodulate and decode content received within a number (M) of sequential or parallel pulses within any of a number (N) of narrower bands of a multiband ultra-wideband signal, wherein the number of sequential or parallel pulses (M) within at least a subset of such narrower bands (N) is greater than one (1).

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

Example Transmitter Architecture

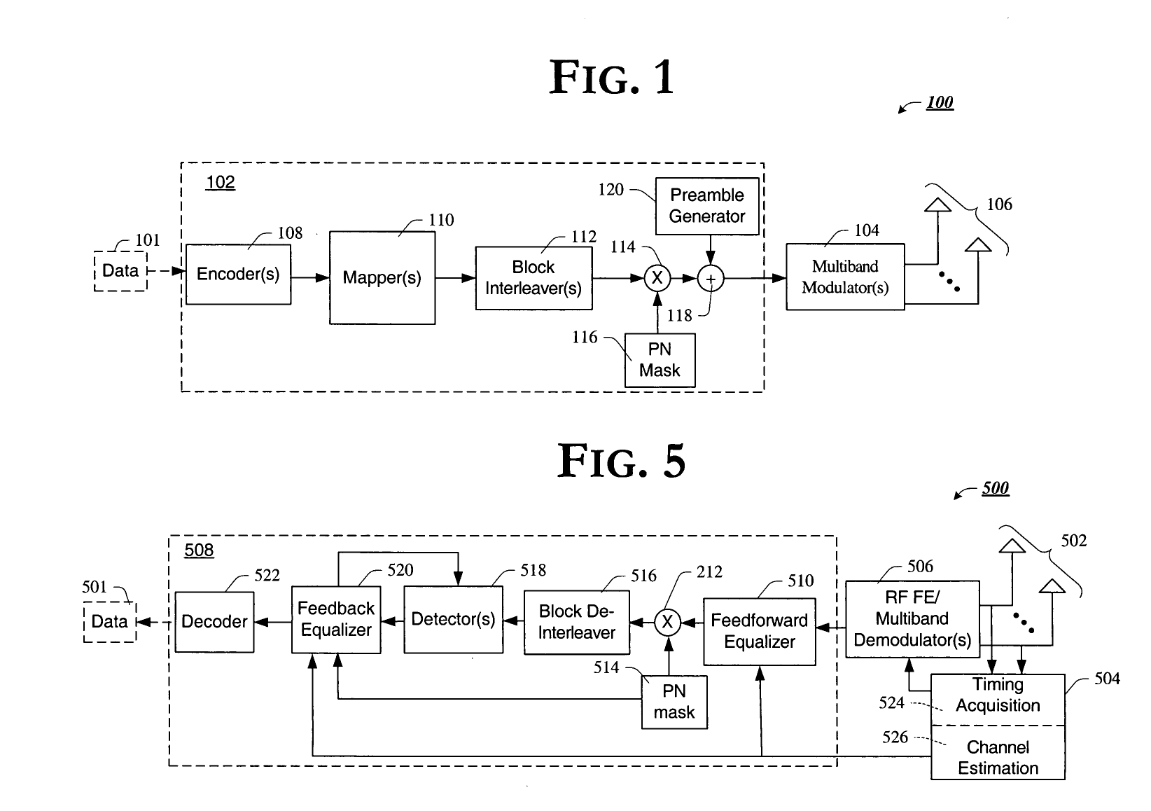

FIG. 1 is a block diagram of an example transmitter architecture, according to one example embodiment of the invention. More particularly, FIG. 1 illustrates an example transmitter architecture designed to transmit a multiband ultra-wideband (MB-UWB) signal, according to one aspect of the present invention. In accordance with the illustrated example embodiment of FIG. 1, transmitter 100 may comprise a transmitter front end 102, which receives informational content (e.g., audio, video, data or combination(s) thereof) 101, processes the received informational content to encode and channelizes the received information, before passing the content to a radio frequency (RF) backend including, e.g., one or more multiband modulator(s) 104 and antenna(e) 106 for transmission, although the invention is not limited in this respect. Although depicted as a number of disparate functional elements, those skilled in the art will recognize that transmitter architectures of greater or lesser complexity which nonetheless perform the functions described herein are anticipated within the scope and spirit of the present invention.

In accordance with the illustrated example embodiment, transmitter front end 104 may comprise one or more encoder(s) 108, mapper(s) 110, interleaver(s) 112, combiner(s) 114, summing module(s) 118, pseudo-random noise mask generator(s) 116 and/or preamble generator(s) 120, each coupled as shown, although the invention is not limited in this respect. As indicated above, one or more of the elements of transmitter front end 104 may well encode received content 101, digitally modulate and interleave such content, and/or apply channelization information to such received content prior to passing the content to the radio frequency (RF) backend 104, for modulation and transmission.

As depicted, transmitter 100 may receive content for transmission via the MB-UWB communication channel at encoder(s) 108 of the transmitter front end 102, although the invention is not limited in this respect. In accordance with the illustrated example implementation, the content may be grouped into blocks and encoded in encoder(s) 108 to improve a receiver's ability to detect and correct errors to the data encountered in the transmission path. According to one example embodiment, encoder(s) 10 encode the received informational content using Reed-Solomon encoding. In alternate embodiments, encoder 108 may well employ any one or more of Reed-Solomon encoding, Punctured Convolutional coding, concatenated convolutional and Reed-Solomon coding, turbo codes (convolutional or product code based, low-density parity check (LDPC) codes, and the like.

In block 110, the encoded content may be mapped using any of a number of digital modulation/mapping techniques before being interleaved in block 112. According to one example embodiment, transmitter 100 may employ M-ary Binary Orthogonal Keying (MBOK) to produce MBOK encoded data (chips) of content.

The M-ary bi-orthogonally encoded data may then be interleaved, block 112, to spread the encoded information across several blocks, enabling, in part, the use of forward error correction/equalization (FEC) in a receiver of the transmitted communication channel. According to one example embodiment, interleaving the MBOK chips over different frequencies (as discussed below), provides an element of frequency diversity, improving multipath mitigation and overall receiver performance.

In block 114, the M-ary binary orthogonally encoded and interleaved blocks of data may be combined with a deterministic pseudo-random value to uniquely identify the encoded content within a multiple access communication channel. While deterministic, the pseudo random code will appear random to unintended receivers of the communication channel. In this regard, the introduction of the pseudo-random value may enable multiple access within the UWB spectrum. According to one example implementation, the pseudo-random value applied to the encoded and interleaved blocks of content may be in the form of a mask generated by a pseudo-noise (PN) generator 116, as shown. The PN mask limits the probability of cross correlation, while providing suitable multipath rejection (auto-correlation).

According to one example implementation, transmitter 100 may employ a combination of Direct Sequence (DS)/Frequency Hopping (FH) Code Division Multiple Access channelization techniques with optional Frequency Division Multiplexing (FDM) which is enabled, in part, though application of the random PN mask applied, e.g., to every chip (bit) and/or low-rate code. In this regard, different users within, e.g., wireless network, would use a different offset of long PN sequence, although the invention is not limited in this regard.

To enable the frequency hopping aspect of transmitter 100, a frequency hopping (FH) code may also be applied to the encoded informational blocks. Frequency hopping, in the context of an MB-UWB transmitter architecture 100, colloquially defines a process wherein a transmitter moves among a number (N) of narrower frequency bands during transmission, typically on a per-symbol basis. According to one example embodiment, transmitter 100 dynamically transmits in one of seven (7) different bands, although greater or fewer bands are anticipated herein. Thus a frame of data is transmitted sequentially over multiple narrower frequency bands within the UWB spectrum.

According to one example embodiment, the transmitter 100 changes transmission band on a per-symbol basis. According to one example embodiment, the concept of extended time-frequency codes are introduced, wherein the FH code (a time frequency code of “1”) may be multiplied by an extension factor (E_{f}), which defines the number of symbols to be sequentially transmitted within the narrower frequency band before hopping to the next frequency band. According to one embodiment, the extension factor applied may change on a periodic basis such as, e.g., on a per-symbol, per-frame, and/or per-epoch basis.

According to one example implementation, the FH codes are applied to the informational content in the transmitter front end 102. In alternate embodiments, the FH codes are applied to the informational content in the RF backend 104. Regardless the use of such frequency hopping (FH) codes dictate which user is on which frequency band at a given period of time, coordinated use of such codes within an UWB spectrum, along with the PN codes, can provide further channelization between users within a coverage area. The establishment of these sub-nets are colloquially referred to as piconets, and will be discussed more fully below, and provide a level of frequency division multiplexing (FDM) to the transmitter 100.

In summing element 118 of transmitter front end 104, the encoded blocks of data may be amended to include a preamble, dynamically created by preamble generator 120. According to one example implementation, the preamble may be added to the “front” of the encoded content, although the invention is not limited in this respect. According to one example embodiment, the preamble may be comprised of two elements, the first element generated through a number (e.g., 16) of iterations of a CAZAC-16 sequence per band, while the second element is generated through a number (e.g., 12) of iterations of a CAZAC-16 sequence per band. As discussed more fully below, adding a preamble to the encoded content facilitates one or more of timing acquisition, synchronization and/or channel estimation in a receiver of the transmitted signal.

In accordance with the illustrated example embodiment of FIG. 1, RF backend 104 includes one or more multiband modulator(s). As used herein, the multiband modulator(s) 104 modulates encoded content received from the transmitter front end 102, preparing the content for transmission across a number (N) narrower bands within an ultra-wideband spectrum via one or more antenna(e) 106. According to one example embodiment, multiband modulator(s) 104 may pass the received content through a quadrature phase shift-keying (QPSK) modulator, although any of a number of modulation techniques may well be used in the alternative. According to one example embodiment, the FH codes and/or extended FH codes are applied in the multiband modulator(s) 104 to enable multiband transmission. As indicated above, the FH codes cause the transmitter 100 to transmit a frame of data across a number (N) of narrower bands within the ultra-wideband spectrum on a per-symbol basis. The use of an extended time-frequency (or, extended FH) code causes the transmitter to transmit a number (M) of symbols within a given narrower band before moving (hopping) to the next narrower transmission band.

Turning briefly to FIG. 2, a graphical illustration of time-frequency (FH) codes applied to symbols within a frame of content for transmission is presented, according to example embodiments of the present invention. With reference to identifier 200, an example embodiment wherein the extension factor applied to the FH code is one (1), i.e., frequency hopping is occurring on an incremental basis, e.g., on a per-chip basis as shown in graph 200. Thus, for each chip (Tc) within a sub-frame (Tf1), a new frequency band (f1, f2, f3 . . . f7) is selected for transmission.

In graph 250, however, an example embodiment where an extension factor of four (4) is applied, i.e., frequency hopping is occurring after four (4) sequential chips are transmitted within a frequency band, before hopping to the next frequency band. Thus, four chips are transmitted on f1, then four on f2, and so on, as depicted. In this regard, according to one aspect of the invention, transmitter 100 processes the received content to transmit any number of sequential pulses (M) within at least a subset of any number (N) of narrower frequency bands of the UWB spectrum. These pulses can also be transmitted and received in parallel, as in a multi-carrier CDMA or OFDM system.

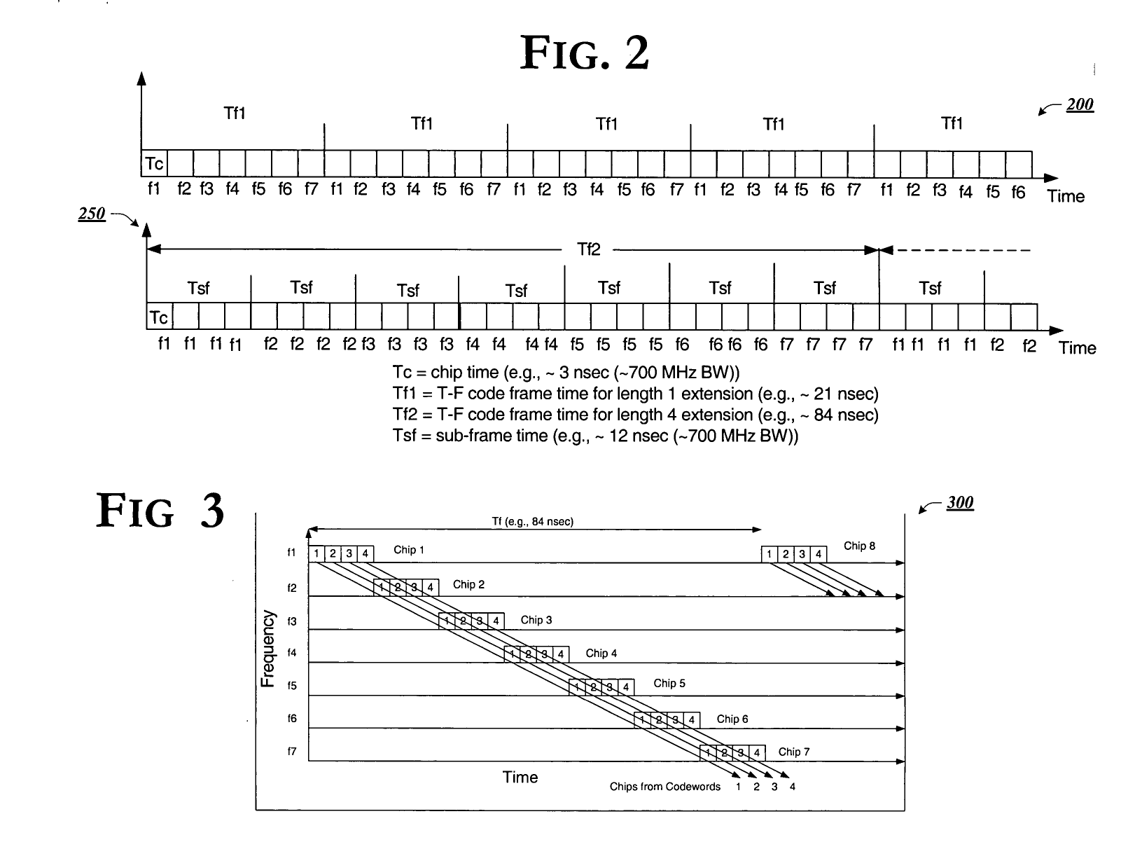

FIG. 3 is a time-frequency graph depicting the use of extended time frequency codes, according to one aspect of the invention. In accordance with the illustrated example embodiment of FIG. 3, graph 300 depicts a number of chips being transmit within a first narrower frequency band (f1) of the UWB spectrum before hopping to the next narrower frequency band (f2) for transmission. More particularly, graph 300 illustrates the block interleaving of four (4) bi-orthogonal codewords (1 . . . 4) with a 6/3 byte interleaving delay (depending on in-phase (I)/quadrature (Q) interleaving strategy). In this regard, the incremental content (chips, symbols, etc.) of a frame (denoted as 1, 2, 3 . . . ) is spread across multiple frequency bands and separated in time (e.g., 84 nanoseconds).

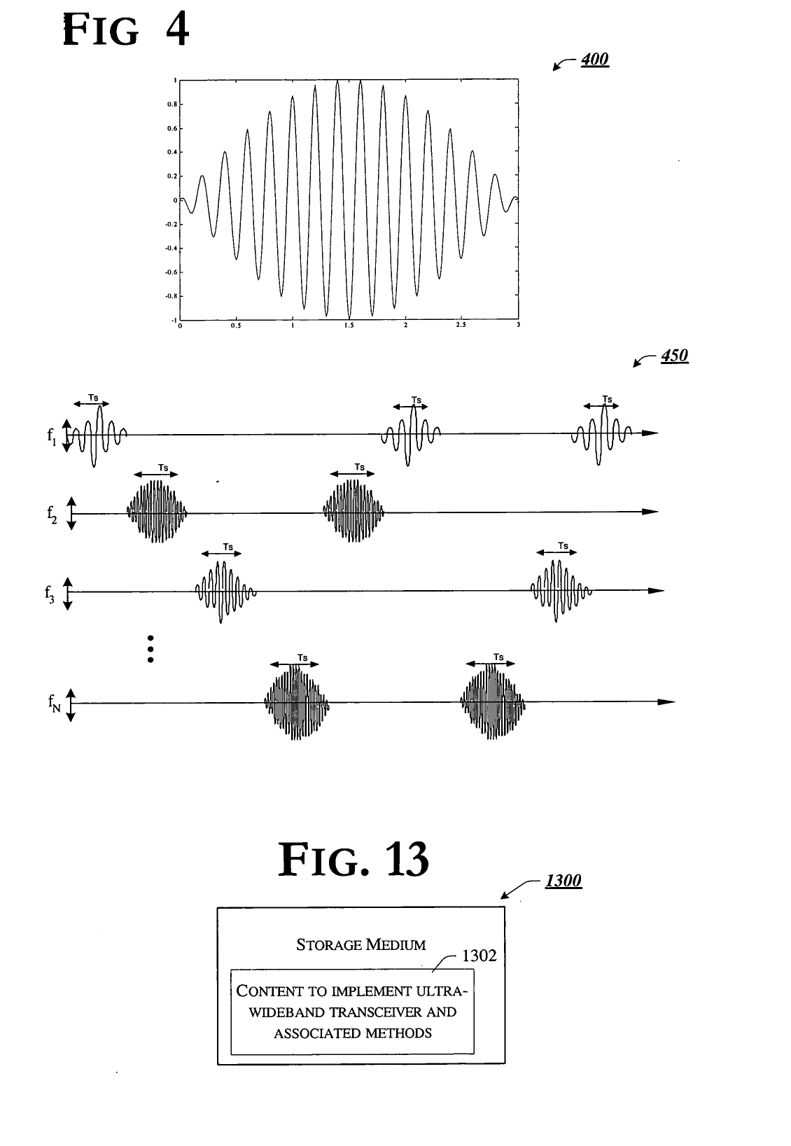

FIG. 4 provides a graphical representation of a modulated frame element (e.g., symbol), in accordance with one example embodiment of the invention. In accordance with one example embodiment of the present invention, RF backend 104 transmits each symbol within the narrower frequency band (f₁, f₂ . . . f_{N}) using a rectified cosine waveform 400, although the invention is not limited in this respect. According to one example implementation, a three (3) nanosecond pulse with a rectified cosine shape is generated with a 700 MHz bandwidth, and 550 MHz channel separation. According to one example implementation, to reduce the effect of interference (e.g., narrowband interference) and/or channel overlap, a frequency separation offset of 275 MHz may be selectively applied by transmitter 100. The transmission of symbols using a FH codes is presented with reference to graph 450.

Example Receiver Architecture

FIG. 5 is a block diagram of an example receiver architecture, according to one example embodiment of the invention. In accordance with the illustrated example embodiment of FIG. 5, receiver 500 may comprise one or more antenna(e) 502, timing acquisition and channel estimation block(s) 504, RF front end and multiband demodulator(s) 506, and a receiver backend 508, each coupled as depicted, although the scope of the invention is not limited in this respect.

According to one example embodiment, receiver 500 may be applied to detect, demodulate and/or decode (or, combinations thereof) content received via one or more antenna(e) 502 embedded within a number (M) of sequential or parallel pulses within a number (N) of narrower bands of a multiband ultra-wideband (UWB) signal, wherein the number of sequential or parallel pulses (M) within any given narrower band is greater than one (1). Those skilled in the art will appreciate that although depicted as a number of disparate elements, receiver architectures of greater or lesser complexity that nonetheless perform the function(s) described herein are anticipated within the scope and spirit of the present invention.

As shown, receiver 500 may include a radio frequency (RF) front end and multiband demodulator(s) 506 coupled with one or more receive antenna(e) to receive ultra-wideband signals. The RF front end/multiband demodulator(s) 506 include elements that may receive and digitize multiband signals received within any of a number (N) of narrower bands (f₁ . . . f_{N}) within and comprising an ultra-wideband signal impinging on one or more antenna(e) 202. Such digitized content may then be passed to receiver backend 508, for further processing and decoding to recover the encoded content embodied within the received signals.

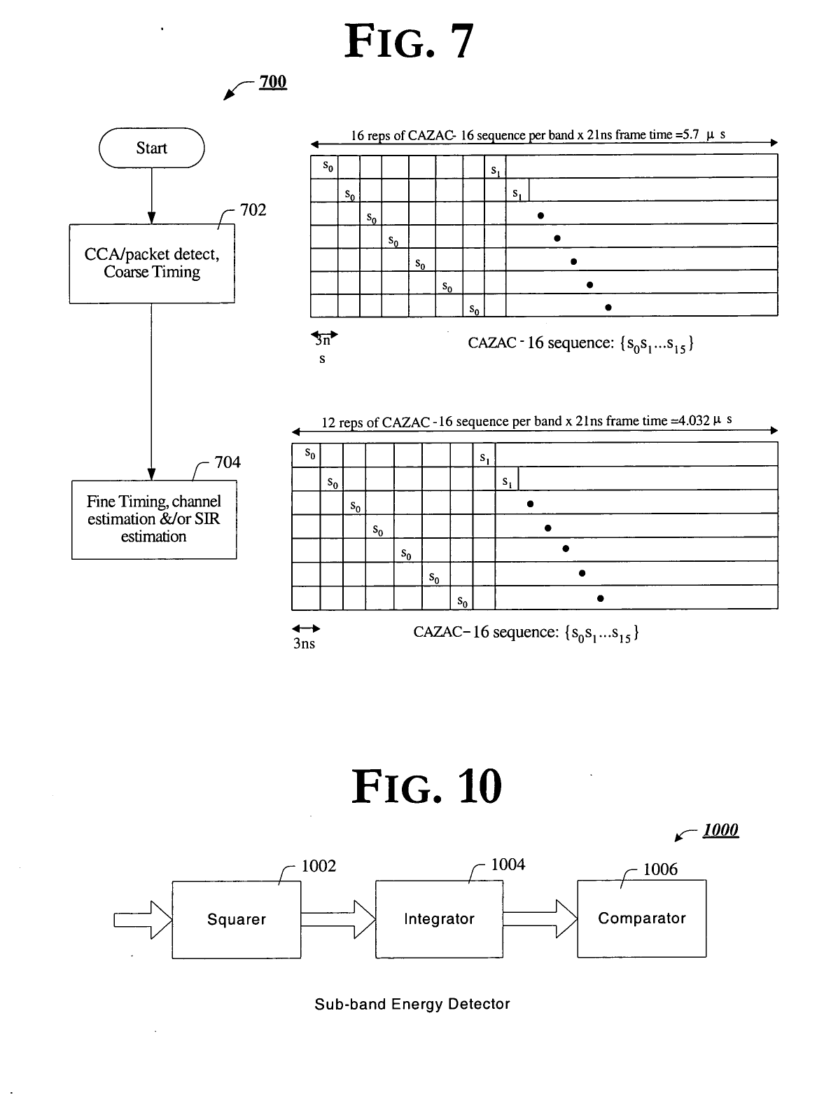

To facilitate channel detection, receiver 500 is depicted comprising a timing is acquisition/channel estimation element(s) 504, responsive to the signals received via antenna(e) 502. As will be discussed more fully below, timing acquisition/channel estimation element(s) 504 may be coupled with one or more of the RF front end/multiband demodulator(s) 506 and/or element(s) of the receiver backend 508 to facilitate one or more of channel acquisition, narrowband interference (NBI) mitigation and/or content decoding, error correction and recovery. As used herein, timing acquisition/channel estimation element 504 may identify received communication channels and provides timing synchronization information to one or more of the RF front end/multiband modulator(s) and/or elements of the receiver backend 508. A block diagram of an example timing acquisition/channel estimation element 504 and a flow chart depicting a preamble detection method will be developed more fully below, with reference to FIGS. 7-9.

RF front end and multiband demodulator(s) 506 may demodulate signal(s) detected within one or more of the number (N) of narrower bands of the ultra-wideband (UWB) signal. According to one example embodiment, RF front end and multiband demodulator(s) 506 is selectively responsive to one or more of a number (N) of narrower bands within an ultra-wideband spectrum to detect and demodulate at least a subset of signal content received therein. According to one embodiment, RF front end/multiband demodulator(s) 506 employ information received from timing acquisition/channel estimation element 504 in the acquisition and demodulation of such received signal(s).

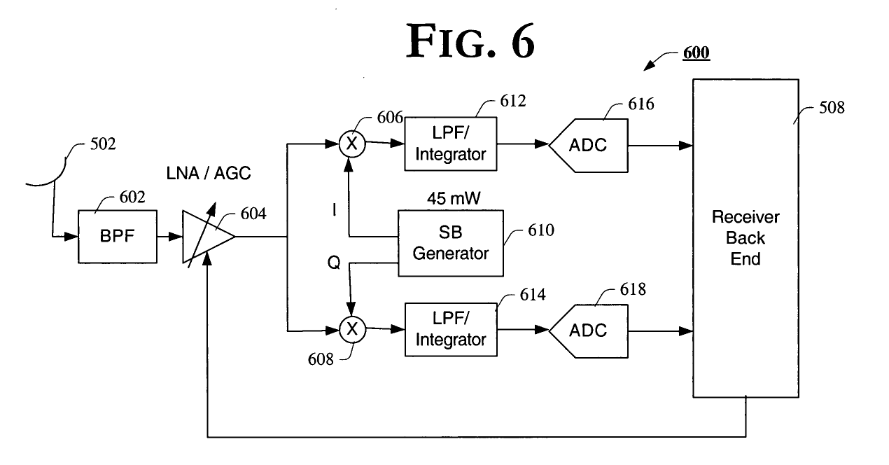

According to one example embodiment, RF front end/multiband demodulator(s) 506 may apply a number of demodulation mechanisms to the received signal(s). According to one example embodiment, multiband demodulator(s) 506 apply a demodulation mechanism that is complementary to the modulation mechanism employed at a transmitter. According to one example embodiment, multiband demodulator(s) 506 apply a quadrature phase shift-keying (QPSK) demodulation to at least a subset of the received signal(s). According to one embodiment, receiver 200 may dynamically adapt to accommodate any of a number of modulation techniques. A block diagram of an example RF front end/multiband demodulator 506 will be developed more fully below, with respect to FIG. 6.

According to one example embodiment, the demodulated content from the RF front end/multiband demodulator(s) is applied to a receiver backend 508. In accordance with the illustrated example implementation of FIG. 5, receiver backend 508 is depicted comprising one or more of feedforward equalizer(s) 510, combiner(s) 512 with associated PN mask generator(s) 514, deinterleaver(s) 516, detector(s) 518, feedback equalizer(s) and/or decoder(s) 522, each coupled as depicted, although the invention is not limited in this respect.

As shown, content received from the RF front end 506 may be passed through a feedforward equalizer 510 to perform a first pass of correcting block errors encountered during signal transmission. According to one example implementation, the feedforward equalizer may be a rake type receiver that captures the energy from multipath by using a maximal-ratio combiner (MRC) to ‘rake’ in the energy from different reflected paths arriving at the receiver. Alternatively, this feedforward equalizer may be implemented as a minimum mean-square-error (MMSE) filter that balances noise enhancement, energy capture, and self interference. In this regard, according to one example embodiment, the MMSE filter could be implemented in a block form using one or more of the channel estimates, creating a channel correlation matrix, and generating the inverse of the correlation matrix in conjunction with a steering vector to create the MMSE filter taps. Alternatively, the MMSE filter coefficients could be trained using a standard LMS or fast RLS algorithm and an appropriate preamble sequence at the beginning of a packet for training. The resultant content is passed through a combiner 512 wherein a generated PN mask 514 is applied to the content. Receiver 500 employs the PN mask to decode, at least in part, content associated with given channel.

This PN decoded content may be applied to a deinterleaver 516. According to one embodiment, deinterleaver 516 applies a complement to the interleaving algorithm to de-interleave the blocks of data received across the multiple frequency bands of the received signal.

The deinterleaved content may be applied to detector(s) 518. According to one embodiment, detector(s) 518 applies a complement to the mapping process performed in a transmitter of the signal. According to one example embodiment, detector(s) 518 performs inverse M-ary binary orthogonal keying to further decode the received content. It will be appreciated that, as a transmitter may well use any of a number of mapping functions, the receiver may well similarly apply any of a number of complementary detector functions with which to decode such content.

The content decoded in detector(s) 518 may be applied to a feedback equalizer 520. According to one example embodiment, feedback equalizer 520 analyzes the decoded content to correct at least a subset of errors identified therein. According to one embodiment, feedback equalizer 520 may provide information back to the detector(s) 518 to be applied in the detector processes. As introduced above, the feedforward equalizer, detector(s) and feedback equalizers may well be implemented as an iterative decoding process. A block diagram of an example iteration of such process is presented with reference to FIG. 11, below.

Content from the feedback equalizer 520 may then be applied to decoder 522. According to one embodiment, decoder 522 applies a complement to the error correction scheme applied at the transmitter, e.g., Reed-Solomon decoding. As above, receiver 500 may well apply any of a number of decoding techniques at decoder 522 to accommodate any of a number of coding techniques employed by the transmitter. In this regard, decoder 522 may well apply any one or more of Reed-Solomon decoding, punctured convolutional decoding, turbo decoding, concatenated convolutional and Reed-Solomon coding, low-density parity check (LDPC) decoding, and the like.

As shown, the output of the receiver backend 508 is a representation 501 of the informational content transmitted from a remote transmitter via the MB-UWB signal.

FIG. 6 illustrates a block diagram of an example radio frequency front end, according to one example embodiment of the present invention. According to one example embodiment, receiver front end 600 is depicted comprising one or more of a filter 602, amplifier element(s) 604, a sub-band frequency generator 610, and parallel processing paths including one or more of combiner(s) 606, 608, filter/integrator(s) 612, 614 and analog to digital converter(s) 616, 618, each coupled as shown, although the invention is not limited in this respect.

As shown, receiver front end 600 receives signal content from one or more antenna(e) 502 at one or more filter element(s) 602. In accordance with the illustrated example embodiment, the filter element(s) 602 may be bandpass filters.

The filtered signal content may then be applied to one or more amplifier elements 604. According to one example implementation, the amplifier elements may include a low-noise amplifier (LNA) with auto-gain control (AGC) features.

The output of the amplifier element(s) 604 may then be split into parallel processing paths. According to one example implementation, the parallel processing paths are associated with an in-phase (I) representation of the received signal, and a quadrature phase (Q) representation of the received signal. As introduced above, each of such processing paths may include a combiner element 606. According to one example implementation, the combiner element may multiply the content received from the amplifier(s) 604 with a signal received from sub-banded generator 610. According to one embodiment, the signal received from SB generator 610 at the two combiners will be out of phase with one another (e.g., by ninety degrees).

As shown, combiner(s) 606, 608 may well be coupled with a filter/integrator element(s) 612, 614. According to one embodiment, the signal is passed through a low pass filter (LPF) before being processed through an analog integrator circuit 612, 614, although the invention is not limited in this respect

The resultant of the filter/integrator element(s) 612, 614 is passed to analog to digital converter(s) (ADC) 616,618, although the invention is not limited in this respect. In this regard, the analog representation of the received signal(s) are digitized for further demodulation, error correction and decoding in the receiver backend 508, as introduced above.

FIG. 7 is a flow chart of an example preamble detection method, according to one embodiment of the present invention. In accordance with the illustrated example method of FIG. 7, the method begins with block 702, wherein receiver (e.g., 500) searches for signal energy in at least a subset of the number (N) of narrower bands within the ultra-wideband spectrum. According to one embodiment, the signal energy may be associated with a beacon or other data bearing signal, which contains preamble information associated with a communication channel.

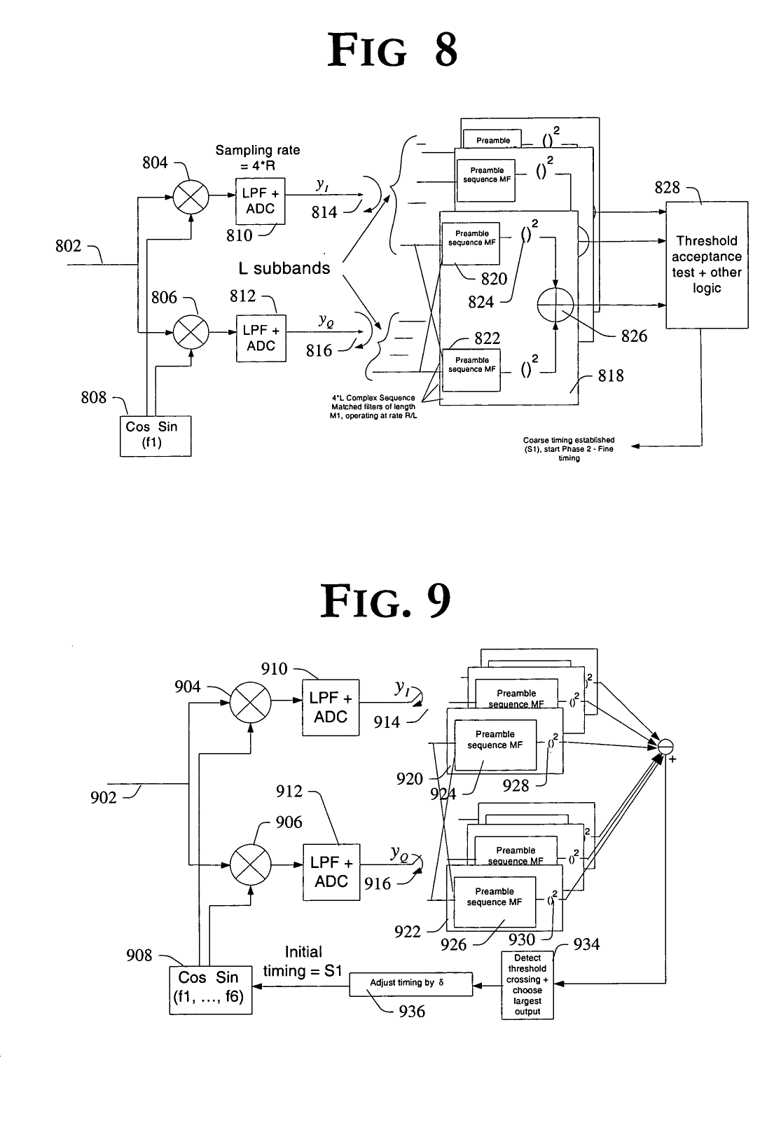

According to one example embodiment, receiver 500 performs channel clearance activity, searching for signal energy within one or more of said N narrower bands that exceeds a threshold. According to one example embodiment, receiver 500 randomly checks each of the N narrower bands to identify signal energy. In one embodiment, a rake receiver architecture may well be employed to detect energy in any of a number N of the narrower bands simultaneously. An example coarse timing acquisition circuit is presented in the block diagram of FIG. 8.

Briefly, FIG. 8 illustrates a block diagram of an example coarse timing acquisition circuit, according to one embodiment of the present invention. In accordance with the illustrated example embodiment of FIG. 8, a received signal 802 may be split into parallel processing paths including, for example, an in-phase processing path and a quadrature phase processing path. In this regard, one or more of the processing paths may include combiner element(s) 804, 806, input from a sub-banded signal generator 808, a filter and analog to digital converter element(s) 810, 812, and demultiplexing element(s) 814, 816, to distribute the signal from the processing path(s) to a number of preamble sequence detector(s) 818 associated with, for example, each of a plurality (L) of sub-bands through which the signal may be received.

As shown, the preamble sequence detectors 818 may include preamble sequence filters 820, 822. According to one embodiment, the filters may be matched to pass the preamble sequence associated with the given band. The output of the matched filters may be squared, block 824, before being summed, block 826. In block 826 the sum of the squared envelope of outputs from the filters may be generated, and passed to detection logic, block 828. According to one example implementation, detection logic 828 determines whether the level of outputs associated with the preamble within a given band exceeds a threshold, indicating the presence of a signal within said band. In this regard, detection logic 828 may be used to initialize the pulse timing and frequency sequence to realize a MB-UWB correlator receiver. If so, returning to FIG. 7, timing acquisition element 504 of receiver 500 implements a fine timing acquisition, block 704.

Upon detecting a signal and performing coarse timing acquisition in block 702, block 704 may be selectively performed to perform fine timing synchronization, according to one aspect of the invention. An example circuit for performing fine timing acquisition is presented in the block diagram of FIG. 9.

Turning to FIG. 9, a block diagram of an example fine timing acquisition circuit, according to one embodiment of the invention. In accordance with the illustrated example embodiment of FIG. 9, a received signal 902 may be split into parallel processing paths including, for example, an in-phase processing path and a quadrature phase processing path. In this regard, one or more of the processing paths may include combiner element(s) 904, 906, input from a sub-banded signal generator 908, a filter and analog to digital converter element(s) 910, 912 and demultiplexing element(s) 914, 916, to selectively distribute the signal from the processing path(s) to a number of preamble sequence detector(s) 920, 922 associated with, for example, each of a plurality (L) of sub-bands through which the signal may be received. According to one embodiment, described more fully below, fine timing acquisition circuit 900 demodulates all of the (L) subbands using the time-frequency (FH) codes, wherein the coarse timing circuit 800 may well be used to initialize the L subband time-frequency code pulse generator timing element(s) 908.

As shown, the preamble sequence detectors 920, 922 may include a complex preamble sequence filters 924, 926. According to one embodiment, the filters may be matched to pass the preamble sequence associated with the given band. The output of the matched filters may be squared, block 928, 930, before being summed, block 932. In block 932 the sum of the squared envelope of outputs from the filters may be generated, and passed to threshold and crossing detector 934. Detector 934 may adjust the timing of the pulse generator 908 by some value δ, e.g., over a pre-specified range, block 936. When the sum of block 932 has been computed for all offsets δ over this range, the particular offset with the largest value of the above-mentioned sum is chosen for the fine timing of the pulse generator in block 908. According to one example embodiment, timing of the pulse generator 908 may be varied in 6 (e.g., Ins) increments over a range of +/−2 ns around coarse timing.

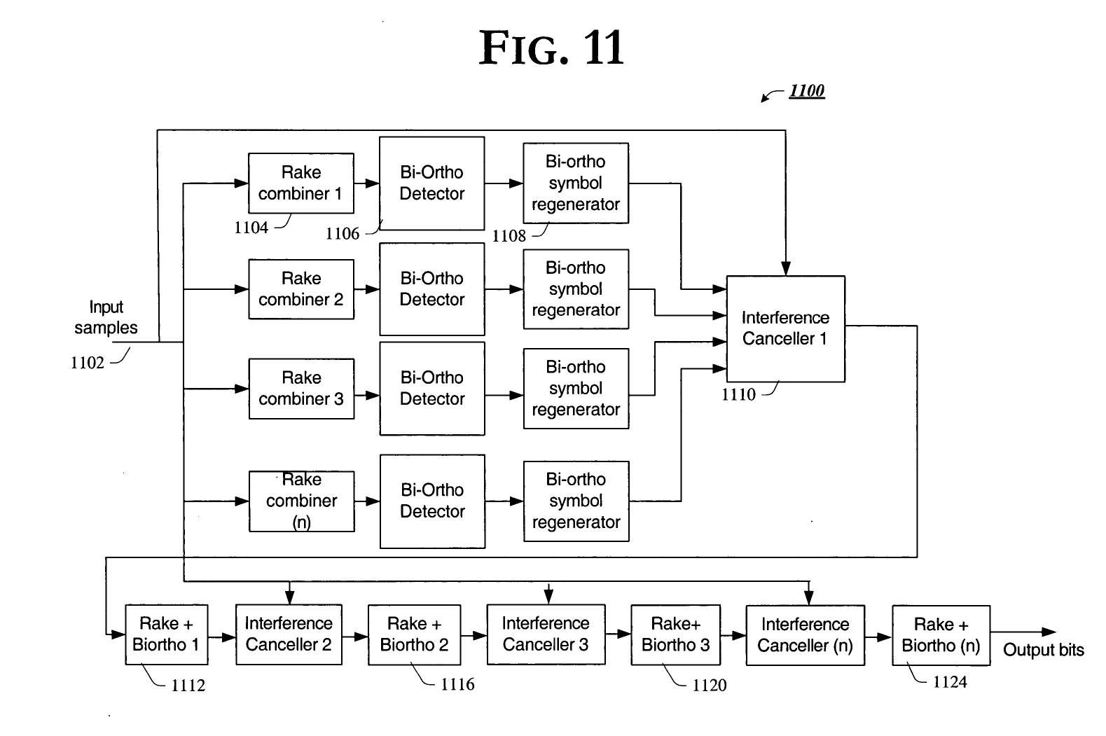

In addition to timing acquisition, channel estimation and demodulation, the RF front end may well include narrowband interference (NBI) mitigation features. In this regard, FIG. 10 provides a block diagram of an example narrowband interference (NBI) detection feature, according to one embodiment of the invention. In accordance with the illustrated example embodiment of FIG. 10, NBI mitigation element 1000 may well comprise one or more of a squarer element(s) 1002, integrator element(s) 1004 and/or comparator element(s), each coupled as shown, although the invention is not limited in this respect. It will be appreciated that narrowband interference detection elements of greater or lesser complexity, that nonetheless perform at least a subset of the functions described herein, are anticipated within the scope and spirit of the present invention.

According to one example embodiment, narrowband interference (NBI) detector 1000 may be thought of as a subband energy detector and does not, in this regard, rely on structural information from the received signal(s) to identify NBI. Alternate implementations are envisaged which exploit signal structure (e.g., 802.11a/b preamble information, etc.) to actively mitigate NBI.

According to one example implementation, upon the detection of strong interferor(s) (e.g., signal to interference ratio (SIR) of greater than −3 dB) as detected by NBI mitigation element 1000, receiver 500 may issue an indication of such NBI to a transmitter. Such indication may be interpreted by the transmitter as a request to avoid transmission within the band experiencing such interference. According to one embodiment, the transmitter may shift the center frequency of the transmission band by some margin, e.g., 275 MHz.

For weaker sources of NBI, mitigation element 1000 may allow the link design within the receiver to remove such interference from the received signal(s), e.g., through the use of MBOK/RS coding, etc.

FIG. 11 is a block diagram of an example subset of the digital back end, according to one embodiment of the present invention. More particularly, one iteration of feedforward equalizer 510, detector 518 and feedback equalizer 520 are depicted, according to one example embodiment of the invention. As introduced above, content from the receiver front end may well be passed through multiple iterations of this decoding element 1100.

In accordance with the illustrated example implementation of FIG. 11, decoding element 1100 is depicted comprising one or more of rake combiner(s) 1104(1) . . . (N), binary orthogonal detector(s) 1106(1) . . . (N), binary orthogonal symbol regenerator(s) 1108(1). (N), interference canceller(s) 1110(1) . . . (N), and rake/bi-ortho detector(s) 1112(1) . . . (N), each coupled as shown. Although illustrated as a number of disparate functional elements, those skilled in the art will appreciate from the disclosure herein that decoder elements 1100 with greater or fewer functional blocks are anticipated within the scope and spirit of the present invention. In addition, this feedforward equalizer could be a minimum mean-square-error (MMSE) filter that balances noise enhancement, energy capture, and self-interference. The MMSE filter could be implemented in a block form using the channel estimates, creating a channel correlation matrix, and generating the inverse of the correlation matrix in conjunction with a steering vector to create the MMSE filter taps. Alternatively, the MMSE filter coefficients could be trained using a standard LMS or fast RLS algorithm and an appropriate preamble sequence at the beginning of a packet for training.

As depicted in FIG. 11, input samples 1102 may be received from, e.g., receiver front end 506 and passed to a number of Rake combiner(s) 1104(1) . . . (N) as well as one or more interference canceller(s) 1110(1) . . . N. The rake combiner(s) 1104 may combine the energies from the various fingers of the rake receiver for presentation to binary orthogonal detector 1106. As used herein, binary orthogonal detector 1106 attempts to identify the MBOK codes within the received signals.

In block 1108, the signals may be passed to binary orthogonal symbol regenerators, to decode the MBOK encoded symbols. This decoded information may then be passed to interference canceller(s) 1110. Those skilled in the art will appreciate, from the discussion above, that MBOK is but an example of suitable encoding schemes and, as such, the implementation of FIG. 11 may well be dynamically modified by receiver 500 to suit any of a number of coding/decoding schemes (codec) listed above. In this regard, the names of the elements 1104-1108 and 1112 may well be modified to reflect the codec actually implemented for a given wireless communications environment.

As shown, the output of such interference canceling element(s) 1110 may be passed to one or more subsequent rake combiner, detector, and symbol regenerator elements 1112, 1116, 1120, 1124, with additional interference cancellation elements interspersed therebetween, as shown, to provide a robust decoding/interference canceling receiver architecture.

It should be appreciated that the foregoing discussion details example embodiments of an example novel ultra-wideband transmitter architecture and associated methods, as well as an novel ultra-wideband receiver architecture and associated methods. It is envisioned, that one or more of such elements may well be combined with one another and/or legacy elements to create a novel ultra-wideband transceiver architecture. Embodiments may well include the novel ultra-wideband transmitter and associated methods in combination with a legacy ultra-wideband receiver, a legacy UWB transmitter in combination with the disclosed UWB receiver and associated methods, and/or the novel UWB transmitter and associated methods in combination with the novel UWB receiver architecture and associated methods. Any one or more of the foregoing embodiments may well be implemented in silicon, hardware, firmware, software and/or combinations thereof. wideband transmitter and associated methods in combination with a legacy ultra-wideband receiver, a legacy UWB transmitter in combination with the disclosed UWB receiver and associated methods, and/or the novel UWB transmitter and associated methods in combination with the novel UWB receiver architecture and associated methods. Any one or more of the foregoing embodiments may well be implemented in silicon, hardware, firmware, software and/or combinations thereof.

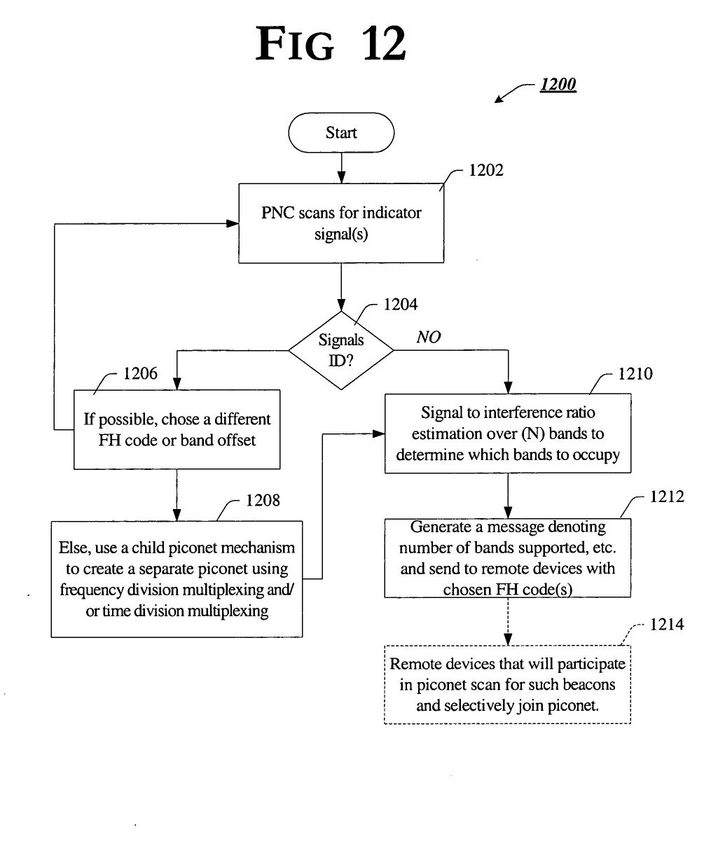

Turning next to FIG. 12, a network control function performed by one or more of transmitter architecture 100, receiver architecture 500 or one of the transceiver architectures introduced above will be described. More particularly, in accordance with another aspect of an embodiment of the invention, FIG. 12 illustrates a flow chart of an example method for establishing piconets, according to one example embodiment of the invention.

In accordance with the illustrated example embodiment of FIG. 12, the method begins in block 1202 wherein a piconet controller (PNC) may scan for signals denoting potential interferors. As introduced above, the piconet controller (PNC) may well be embodied within the transmitter architecture, receiver architecture, a transceiver, or none thereof. According to one example embodiment, the indicator signals may be beacon signals from, e.g., another PNC. More particularly, PNC may search for indicator signals employing the time-frequency (or, frequency hopping (FH)) code that the PNC desired to use for its indicator signal.

In block 1204, PNC may determine whether any indicator signals were identified. If a conflicting indicator signal is identified (block 1204), PNC may attempt to use an alternate time-frequency (FH) code, if available, block 1206, as the process returns to block 1202.

If no alternative FH codes are available, PNC may attempt to establish a child piconet network using additional multiplexing techniques. In this regard, PNC may well attempt to establish a child piconet network employing one or more of frequency division multiplexing, time division multiplexing, etc. in combination with the FH codes.

In block 1210, upon the establishment of a child piconet, or if no interfering indicator signals were detected in block 1204, PNC may scan up to (N) desired transmission bands to identify potential sources for interference.

In block 1212, PNC may generate a message for transmission to remote piconet members denoting the number of bands supported, the FH codes to employ within each of said bands, etc.

In block 1214, receiving devices (denoted with the dashed lines) that will participate in the piconet may scan for such messages from PNC and selectively join the piconet, adopting at least a subset of the operating parameters (select bands, FH codes, etc.).

Alternate Embodiment(s)

It will be appreciated by those skilled in the art that the foregoing was but a mere illustration of the teachings of the present invention, as other embodiments and implementations are anticipated within the scope of the invention. Examples of such alternate embodiments are briefly described below.

FIG. 13 is a block diagram of an example storage medium comprising executable content which, when executed by an accessing appliance, may cause the appliance to implement one or more aspects of the innovative ultra-wideband transceiver architecture and associated methods described above. In this regard, storage medium 1300 includes content 1302 to implement a transceiver architecture to generate and or receive a multiband ultra-wideband (MB-UWB) signal comprising any number (M) of sequential pulses within any number (N) of narrower frequency bands that compose an UWB signal, in accordance with one embodiment of the present invention.

As used herein, the machine-readable medium 1300 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a wired/wireless modem or network connection).

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps. The steps of the present invention may be performed by hardware components, or may be embodied in machine-executable content (e.g., instructions), which may be used to cause a general-purpose or special-purpose processor or logic circuits programmed with the instructions to perform the steps. Alternatively, the steps may be performed by a combination of hardware and software. Moreover, although the invention has been described in the context of a network device, those skilled in the art will appreciate that such functionality may well be embodied in any of number of alternate embodiments such as, for example, integrated within a computing device (e.g., a server).

Many of the methods are described in their most basic form but steps can be added to or deleted from any of the methods and information can be added or subtracted from any of the described messages without departing from the basic scope of the present invention. Any number of variations of the inventive concept are anticipated within the scope and spirit of the present invention.

In this regard, the particular illustrated example embodiments are not provided to limit the invention but merely to illustrate it. Thus, the scope of the present invention is not to be determined by the specific examples provided above but only by the plain language of the following claims.

1. An apparatus comprising:
a transmitter, to generate a multiband ultra-wideband (MB-UWB) signal for transmission via one or more antenna(e), wherein the generated MB-UWB signal is composed of a number (N) of narrower band pulses in a number of different frequency bands, wherein the number (M) of sequential or parallel pulses within a given narrower band is greater than one (1) pulse.

2. An apparatus according to claim 1, the transmitter comprising:
a front end, to encode received content for transmission through select ones of the narrower band pulses of the generated multiband ultra-wideband signal.

3. An apparatus according to claim 2, the transmitter front end comprising:
one or more encoder(s), to receive the content and incorporate error correction information therein.

4. An apparatus according to claim 3, wherein the one or more encoder(s) performs one or more of Reed-Solomon encoding, punctured convolutional encoding, concatenated convolutional encoding in combination with Reed-Solomon encoding, turbo coding and/or low density parity check (LDPC) coding on the received content to enable the detection and correction of burst errors within a received signal at a remote receiver.

5. An apparatus according to claim 2, the transmitter front end comprising:
one or more mapper(s), responsive to the encoder(s), to perform M-ary Binary Orthogonal Keying (MBOK) on the encoded content.

6. An apparatus according to claim 5, the transmitter front end further comprising:
one or more interleaver(s), responsive to the binary-orthogonal mapper(s), to interleave the encoded content across a number (N) of blocks of content.

7. An apparatus according to claim 6, wherein the encoded content is interleaved across four (4) blocks of content.

8. An apparatus according to claim 6, the transmitter front end further comprising:
a combiner element(s), responsive to the interleaver(s), to receive interleaved content and apply a pseudo-random noise (PN) mask thereto.

9. An apparatus according to claim 8, the transmitter front end further comprising:
a summing element(s), responsive to the combiner, to receive masked content and apply a preamble thereto, wherein the preamble facilitates timing synchronization and channel estimation in a receiver of the multiband ultra-wideband (MB-UWB) signals.

10. An apparatus according to claim 9, the transmitter further comprising:
an radio frequency (RF) backend, responsive to the transmitter front end, to receive the encoded content from the front end, modulate the received content and prepare it for transmission across a number (N) of pulses within relatively narrow bands of an ultra-wideband (UWB) spectrum.

11. An apparatus according to claim 10, the RF backend comprising:
a multiband modulator(s), responsive to the transmitter front end, to receive the encoded content and modulate the received content using quadrature phase shift-keying (QPSK).

12. An apparatus according to claim 10, wherein the multiband modulator(s) modulate the received content using binary phase shift-keying (BPSK).

13. An apparatus according to claim 2, the transmitter front end further comprising:
one or more interleaver(s), responsive to the encoder(s), to interleave the encoded content across a number (N) of blocks of content.

14. An apparatus according to claim 2, the transmitter front end further comprising:
a combiner element(s), responsive to the encoder(s), to receive encoded content and apply a pseudo-random noise (PN) mask thereto.

15. An apparatus according to claim 2, the transmitter front end further comprising:
a summing element(s), responsive to the encoder(s), to receive encoded content and apply a preamble thereto, wherein the preamble facilitates timing synchronization and channel estimation in a receiver of the multiband ultra-wideband (MB-UWB) signals.

16. An apparatus according to claim 15, wherein the preamble is generated through a number of instances of a CAZAC-16 sequence for at least a subset of the narrower bands of the ultra-wideband signal.

17. An apparatus according to claim 1, the transmitter comprising:
an radio frequency (RF) backend, responsive to the transmitter front end, to receive the encoded content from the front end, modulate the received content and prepare it for transmission across a number (N) of pulses within relatively narrow bands of an ultra-wideband (UWB) spectrum.

18. An apparatus according to claim 17, the RF backend comprising:
a multiband modulator(s), responsive to the transmitter front end, to receive the encoded content and modulate the received content using quadrature phase shift-keying (QPSK).

19. An apparatus according to claim 1, further comprising:
a storage device having stored therein executable content which, when executed, enables an accessing device to implement the transmitter.

20. An apparatus according to claim 1, further comprising:
a receiver, coupled with one or more antenna(e), to receive and demodulate each of a number (N) of pulses spread across multiple narrower bands of an ultra-wideband spectrum to recover content embedded therein.

21. An apparatus according to claim 1, further comprising:
one or more antenna(e), through which the apparatus can transmit and/or receive multiband ultra-wideband signal(s).

22. An apparatus according to claim 21, wherein the apparatus employs frequency division duplex (FDD) to enable simultaneous transmission and reception on separate frequencies using a common antenna(e).

23. An apparatus according to claim 1, wherein the transmitter is the apparatus.

24. An apparatus according to claim 1, where the number (N) of narrower bands is between two (2) and twenty (20), while the number of sequential or parallel pulses is between two (2) and one hundred.

25. An apparatus according to claim 24, wherein the number of narrower bands of the ultra-wideband spectrum is fifteen (15) or less, each band 500 megahertz (MHz) wide, supporting 500+ megabits per second (500+Mb/s).

26. An apparatus according to claim 24, wherein the number of sequential pulses within at least a subset of the narrower bands is four (4) or less.

26. An apparatus comprising:
a receiver, responsive to one or more antenna(e), to receive an ultra-wideband (UWB) signal comprised of a number (N) of pulses within narrower bands of an UWB spectrum, wherein the number (M) of pulses within each of the narrower bands is one or more and is dynamically controlled by the receiver and/or transmitter.

27. An apparatus according to claim 26, the receiver comprising:
a channel acquisition element, responsive to the one or more antenna(e), to detect energy within any of the narrower bands of the UWB spectrum, perform timing acquisition/synchronization and channel estimation.

28. An apparatus according to claim 27, the channel acquisition element comprising:
a timing acquisition element, responsive to the one or more antenna(e), to perform one or more of coarse timing acquisition and/or fine timing acquisition based, at least in part, on detection of preamble information within a select band of the number of narrower bands within the UWB spectrum.

29. An apparatus according to claim 26, the receiver comprising:
a radio frequency (RF) front end, to receive signals within one or more of the number (N) of multiple narrower bands of the ultra-wideband (UWB) spectrum, and to demodulate the received signal(s).

30. An apparatus according to claim 29, wherein the demodulation performed by the RF front end is complementary to the modulation performed by a remote transmitter of the received MB-UWB signals.

31. An apparatus according to claim 29, the RF front end to perform quadrature phase shift-keying (QPSK) demodulation of the received signals.

32. An apparatus according to claim 26, the receiver comprising:
a digital backend, to correct at least a subset of errors encountered during transmission and to decode content embedded within a demodulated representation of the received MB-UWB signals to produce a representation of content transmitted to the receiver from a remote transmitter.

33. An apparatus according to claim 32, the digital backend comprising one or more of a feed forward equalizer, a pseudo-noise mask generator, a combiner, a block de-interleaver, a detector, a feedback equalizer, and/or a decoder, coupled to identify and correct at least a subset of errors encountered during transmission of the MB-UWB signals, and to distinguish encoded content embedded within the received signals intended for the receiver from those intended for other receiver(s).

34. An apparatus according to claim 26, further comprising:
one or more antenna(e), coupled to the receiver, through which the receiver receives MB-UWB signals.

35. An apparatus according to claim 34, wherein the apparatus employs frequency division duplexing (FDD) to simultaneously transmit and receive MB-UWB signals via one or more antenna(e).

36. An apparatus according to claim 26, further comprising:
a transmitter, to generate a multiband ultra-wideband (MB-UWB) signal for transmission via one or more antenna(e), wherein the generated MB-UWB signal is composed of a number (N) of narrower band pulses in a number of different frequency bands, wherein the number (M) of sequential pulses within a given narrower band is greater than one (1) pulse.

37. An apparatus according to claim 26, wherein the apparatus is the receiver.

38. A method comprising:
encoding content for transmission via a multiband ultra-wideband (MB_UWB) signal through application of a time-frequency code extension, wherein the time-frequency code extension defines the number (M) of sequential pulses within any of the number (N) of narrower bands comprising a multiband ultra-wideband (MB-UWB) signal.

39. A method according to claim 38, the encoding further comprising:
incorporating one or more error correction codes, multiple access codes, and/or preambles into the content prior to said transmission.

40. A method according to claim 39, wherein the error correction codes include one or more of a Reed-Solomon encoding, punctured convolutional coding, concatenated convolutional coding in combination with Reed-Solomon encoding, turbo coding, and/or low density parity check (LDPC) coding.

41. A method according to claim 38, the encoding further comprising:
applying M-ary binary orthogonal keying (MBOK) codes to the content; and
interleaving said MBOK encoded content.

42. A storage medium comprising content which, when executed by an accessing machine, causes the machine to implement a method according to claim 38.

43. A communication device comprising:
memory having content available therein; and
a control logic, coupled with the memory, to selectively access and execute at least a subset of the content available within the memory to implement a method according to claim 38.

44. A method comprising:
demodulating and decoding content received within a number (M) of sequential pulses within a number (N) of narrower bands of a multiband ultra-wideband (UWB) signal, wherein the number of sequential pulses (M) within any given narrower band is greater than one (1).

45. A method according to claim 44, further comprising:
detecting narrowband interference (NBI) associated with one or more bands of the received MB-UWB signal; and
mitigating harmful effects of the detected NBI within the MB-UWB signal.
